(19) United States
(12) Patent Application Publication
(10) Pub. No.: US 2003/0161240 A1
(43) Pub. Date: Aug. 28, 2003

(54) Disk guide device of compact disk player for automobile

(75) Inventors: Hyun-Chan Park, Yongin-si (KR); Soon-Yong Shin, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/145,813

(22) Filed: May 16, 2002

(30) Foreign Application Priority Data
Feb. 25, 2002 (KR) 2002-9974

(51) Int. Cl. G11B 33/02; G11B 23/00; G11B 25/00

(52) U.S. Cl. 369/77.1; 369/270

(57) ABSTRACT

A disk guide device of a compact disk player for an automobile which is conveniently used regardless of a size of a disk by enabling only one mechanism to drive any of different disks is disclosed. A clamp arm, which is hingedly connected at its rear part to a main body, is provided at the left side of its upper surface with a pusher arm to be rotated. The clamp arm is provided at the right side of its upper surface with a locker arm and a selective arm to be rotated. The clamp arm is provided at its right side with a stopper for selectively stopping rotation of the selective arm. Since the device can drive an 80 mm disk as well as a 120 mm disk by itself, there are economical and practical advantages. Since the guide arm guides a disk while moving linearly, it is possible to achieve favorable operational smoothness and decrease of failure rate.

### BACKGROUND OF THE INVENTION

1. Field of the Invention

The present invention relates to a compact disk player for an automobile, and more particularly to a disk guide device of a compact disk player for an automobile which is adapted to be conveniently used regardless of type of a disk by enabling only one mechanism to drive an 80 mm disk as well as a 120 mm disk.

2. Description of the Prior Art

In general, a compact disk player for an automobile is an appliance for playing back data recorded on a compact disk by an optical system.

Such a compact disk player for an automobile comprises a turntable on which a disk is placed, a loading unit for retracting a disk inserted into an insertion slot and seating the disk on the turntable, a drive for rotating the turntable, a clamping unit for preventing shifting of the disk during rotation of the turntable, an optical pick up for writing data on a disk and reading data from the disk while radially moving on the disk, and a transfer device for moving an optical pick up back and forth.

Such a compact disk player for an automobile, which is adapted to be used in playing back an 80 mm disk and a 120 mm disk in common, is provided with a disk guide device for guiding any the two types of disks to precisely position the central point of the disk on the center of the turntable.

Korean Patent No. 0167068 discloses a compact disk player for an automobile which is adapted to be used in playing back any of an 80 mm disk and a 120 mm disk in common.

Seeing composition of the disk guide device adapted above Korea patent No. 0167068, a lever selector is a lever selector is rotatably supported on a deck frame. The lever selector is provided with guide protrusions for detecting a disk loaded into the deck frame and second protrusions for actuating an arm lock guide. The arm lock guide is located close to the lever selector and mounted on the deck frame to be rotated about a hinge. The arm lock guide is in contact at its end with the second protrusions of the lever selector, and the other end of the arm lock guide is provided with locking portions and adapted to be engaged to a locking pin of a guide arm. When a disk is loaded into the deck frame, the other end of the arm lock guide is rotated by a predetermined angle by the second protrusions formed at one end of the lever selector, the locking portions formed at the other end of the arm lock guide are engaged to or disengaged from the locking pin of the guide arm. Guide arms are provided at facing ends thereof with gear teeth which are engaged with each other such that the guide arms are rotated by the same rotating angle. The other ends of the guide arms are provided with stoppers, which are adapted to be guided along arched guide holes. The guide arm and the arm lock guide are elastically connected by a tension spring. Accordingly, a loaded disk comes into contact with the stoppers positioned depending on 80 mm/120 mm in diameter of the disk.

Since the conventional disk guide device includes two guide arms which are operatively engaged with each other by gears, assembly efficiency of the guide device is decreased due to the increased number of components, and failure frequency is increased due to a complicated operation.

Moreover, as impacts generated by an operation of the compact disk player are repeatedly transmitted to the gear teeth of the guide arms for a long period, the gear teeth of the guide arms are gradually worn, thereby preventing a smooth operation.

### SUMMARY OF THE INVENTION

Accordingly, the present invention has been made keeping in mind the above problems occurring in the prior art, and an object of the present invention is to provide a disk guide device of a compact disk player for an automobile which is reduced in the number of its components to improve assembly efficiency and to reduce manufacturing cost, and which is adapted to guide a disk smoothly in a linear manner, thereby reducing failure frequency.

In order to accomplish the above object, the present invention provides a disk guide device of a compact disk player for an automobile comprising: a clamp arm mounted on a main body, which is hingedly connected at its rear part to the main body and is provided at its front part with a clamp to selectively press a central portion of a disk; a guide arm disposed under the clamp arm to be moved back and forth, which is provided at both ends of a lower surface of the clamp arm with a pair of protrusions to precisely guide the disk to the center of a turntable; and a selective disk reception mechanism disposed on the clamp arm, which is adapted to move the guide arm rearwardly to receive a larger disk thereinto.

The selective disk reception mechanism comprises: a pusher arm coupled to an upper surface of the clamp arm to be rotated to a certain angle, which is provided with a pusher being extended outwardly and being biased to be rotated in the opposite direction of ingression direction of a disk by spring; a locker arm rotatably coupled to an upper surface of the clamp arm, which is connected at one end to the guide arm to bias the guide arm forwardly by a torsion spring and is provided at its upper surface with a protruded locker for selectively interrupting turning force of the locker arm; a selective arm coupled to an upper surface of the locker arm to be rotated together with the locker arm to a certain angle and to be moved laterally, which is provided at one end with a protrusion piece to be put into contact with the pusher and is provided at a portion with a locker guide hole for guiding the locker during rotation of the locker arm, the locker guide hole being formed at its front and rear sides with a pair of locker cuts into which the locker is engaged, and being biased to be rotated in the opposite direction of ingression direction of a disk by spring; and a stopper hingedly coupled at its middle portion to a lower surface of the clamp arm to be rotated up and down, which is provided at its front end with a pin by which the selective arm is caught during its rotation, the pin passing through the clamp arm and being upwardly protruded, and is integrally provided at its rear end with a push plate, a compression spring being dispose between the push plate and the clamp arm to elastically press the push plate upwardly.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a disk guide device of a compact disk player according to the present invention;

FIG. 2 is a perspective view showing an assembled condition of the disk guide device according to the present invention;

FIGS. 3a to 3c show an operation of the disk guide device according to the present invention when a 120 mm disk is seated on a turntable;

FIGS. 4a and 4b show an operation of the disk guide device according to the present invention when an 80 mm disk is seated on a turntable.

### DETAILED DESCRIPTION OF THE INVENTION

This invention will be described in further detail by way of example with reference to the accompanying drawings.

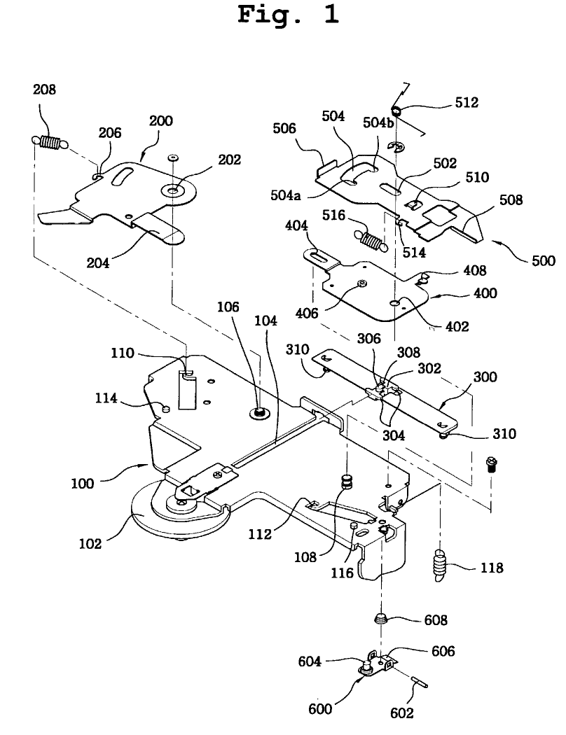

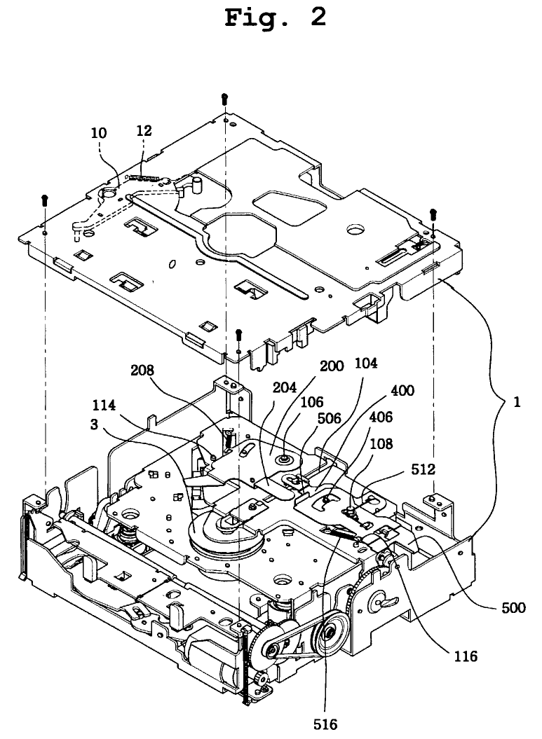

FIGS. 1 and 2 shows a disk guide device of a compact disk player for an automobile according to the present invention.

As shown in the drawings, the disk guide device according to the present invention comprises a clamp arm 100 mounted on a main body 1 with its rear part being rotatably connected thereto, a guide arm 300 disposed under the clamp arm 100 to be moved back and forth, and a selective disk reception mechanism disposed on the clamp arm 100 which is adapted to move the guide arm 300 rearwardly to receive a larger disk when the larger disk is loaded thereinto.

The selective disk reception mechanism comprises a pusher arm 200 provided at the left side of an upper surface of the clamp arm 100, a locker arm 400 provided at the right side of an upper surface of the clamp arm, a selective arm 500 disposed on an upper surface of the locker arm 400, and a stopper 600 disposed under the left side of the clamp arm 100 to be moved up and down.

The clamp arm 100 is hingedly coupled at its rear portion to a rear portion of the player body 1 and is rotated up and down about the hinge axis. Moreover, the clamp arm 100 is elastically connected to the player body 1 by means of a spring 118 to be biased downwardly.

The clamp arm 100 is provided at its front end with a clamp 102 for preventing a disk “D” from being separated from a turntable 3 during rotation of the turntable, and is provided at its center line with a slot 104 opening rearward.

A pusher pin 106 is upwardly protruded at the left side of the slot 104, to which the pusher arm 200 is coupled, and a locker pin 108 is upwardly protruded at the right side of the slot 104, to which the locker arm 400 and the selective arm 500 are coupled.

Furthermore, the clamp arm 100 is provided with a first rotation checking protrusion 114 at a position forwardly spaced from the pusher pin 106, which is intended to limit a rotating angle of the pusher arm 200, and is provided with a second rotation checking protrusion 116 at a position forwardly spaced from the locker pin 108, which is intended to limit a rotating angle of the locker arm 400.

The clamp arm 100 is formed at the left side with a first hook 110 which is defined by cutting the clamp arm into a predetermined shape, and is formed at the right side with a second hook 112 which is defined in the same way as that of the first hook 110.

The pusher arm 200 is coupled to the left side of the upper surface of the clamp arm 100. The pusher arm 200 is formed with a fitting hole 202, which is rotatably fitted on the pusher pin 106 of the clamp arm 100, and is provided at the right end with a pusher 204, which is intended to push the selective arm 500 when the pusher arm is rotated about the pusher pin.

In addition, the pusher arm 200 is provided with a hook 206 on the opposite side of the pusher 204. Accordingly, the hook 206 is connected to the first hook 110 of the clamp arm 100 by means of spring 208, so that the pusher 204 is biased to be rotated in the opposite direction of the ingression direction of a disk. When the pusher arm is rotated in the opposite direction of the ingression direction of a disk, the pusher arm 200 is caught by the first rotation checking protrusion 114 to be limited in its rotating angle.

The guide arm 300 is provided at it middle point with a slider 302 which is upwardly protruded and inserted into the slot 104 of the clamp arm 100 to be slid back and forth. The slider 302 is laterally provided with a plurality of extensions 304 such that the slider 302 cannot be downwardly separated from the slot 104 when the slider 302 is inserted into the slot.

The slider 302 is also provided at its upper surface with a protruded pin 306. The protruded pin 306 is provided at its upper end with a retaining piece 308 extended laterally.

Furthermore, the guide arm 300 is provided at its both ends with protrusions 310 extended downwardly. It is preferable that the protrusions 310 are symmetrically configured so as to precisely guide a loaded disk “D” to the center of the turntable 3.

The locker arm 400 is adapted to be coupled to the right side of an upper surface of the clamp arm 100. The locker arm 400 is provided with a fitting hole 402 into which the locker pin 108 of the clamp arm 100 is rotatably inserted, and is provided at the opposite side with an elongated hole 404 into which the protruded pin 306 of the slider 302 is inserted.

Furthermore, the locker arm 400 is centrally provided with a locker 406 protruded upwardly to selectively intercept turning force of the locker arm 400, and is provided with a protruded piece 408 to which an end of a later-described torsion spring 512 is engaged.

The selective arm 500 is adapted to be coupled to an upper surface of the locker arm 400. The selective arm 500 is formed at its middle portion with an elongated hole 502 into which the locker pin 108 can be inserted, and is formed at the left side of the elongated hole 502 with a locker guide hole 504 into which the locker 406 is can be inserted. The front and rear portions of a side of the locker guide hole 504 are formed with a pair of locker cuts 504a and 504b by which the locker is caught to be held.

In addition, the selective arm 500 is provided at the right side of the elongated hole 502 with an upwardly protruded piece 510, so that the protruded piece 510 is connected to the protruded piece 408 of the locker arm 400 by means of the torsion spring 512.

That is, the torsion spring 512 is inserted on the locker pin 108, and is retained at one end by the protruded piece 510 of the selective arm 500 and retained at the other end by the protruded piece 408 of the locker arm 400, so that the locker arm 400 is biased to be rotated counterclockwise, thereby biasing the guide arm 300 forwardly.

The selective arm 500 is provided at its left end with an upwardly protruded piece 506 to which the pusher 204 of the pusher arm 200 is engaged when the pusher 204 is rotated in the ingression direction of a disk, and provided at its right end with a protruded piece 508 positioned to be perpendicular to the protruded piece 506.

The selective arm 500 is also provided at its front side with a hook 514, so that between the hook 514 and the second hook 112 of the clamp arm 100 is connected a spring 516, thereby biasing the selective arm 500 to be moved rotated clockwise.

The stopper 600 is coupled at its middle portion to a right end of the clamp arm 100 by a hinge pin 602 such that the stopper 600 is swung up and down about the hinge pin 602.

The stopper 600 is provided at its front end with a pin 604, which passes through the clamp arm 100 and is upwardly protruded and by which rotation of the selective arm 500 is limited. The stopper 600 is integrally provided at its rear end with a push plate 606. Between the push plate 606 and the clamp arm 100 is disposed a compression spring 608 to elastically press the push plate 606 upwardly.

In this construction, when the selective arm 500 is caught by the pin 604 of the stopper 600, the guide arm 300 is rearwardly moved by a distance required to position the center of a disk “D” at the center of the turntable. At the same time, the push plate 606 is pushed downwardly by the disk “D” moving rearwardly, so that the pin 604 is lowered, thereby allowing the selective arm 500 to be caught by the rotation checking protrusion 116 beyond the pin 604. Accordingly, the guide arm 300 is moved further backward to be separated from the disk “D”.

An upper frame of the player body 1 is internally provided with a selector lever 10, which is rotated to push the pusher arm 200, thereby rotating the pusher 204 in the ingression direction, when the disk “D” is loaded into the player body.

A spring 12 is connected between the selector lever 10 and the player body 1, so that the selector lever 10 is elastically restored to a normal position when the central point of a disk “D” is located at the center of the turntable 3.

Functions of the disk guide device of a compact disk player for an automobile according to the present invention will now be described.

First, an operation of the disk guide device according to the present invention is described when a 120 mm disk is loaded into the player body.

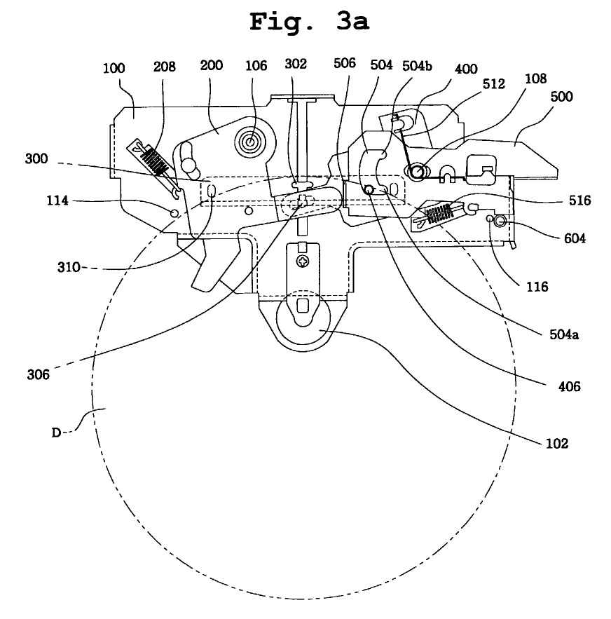

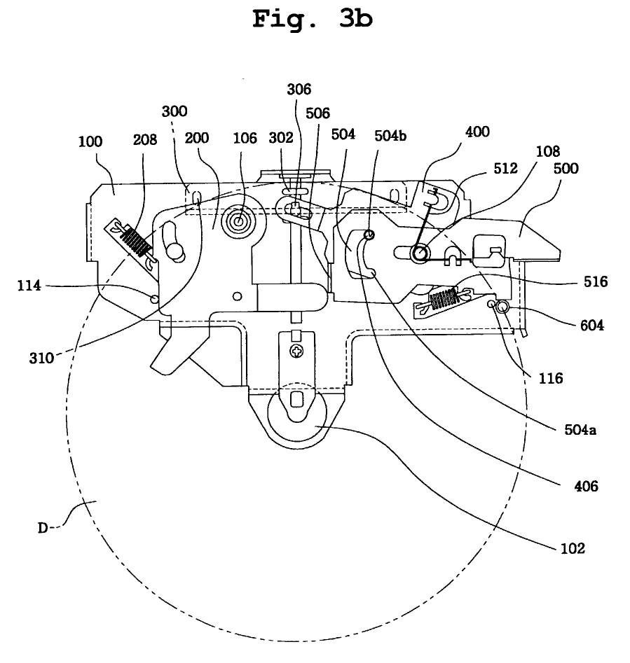

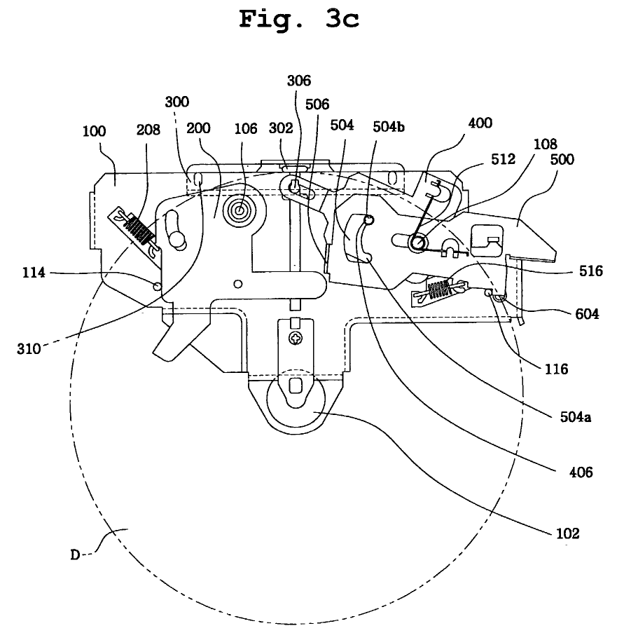

As the disk “D” is pushed and inserted, the selector lever 10 is rotated by the disk “D”, and the rotating selector lever 10 pushes the pusher arm 200 to be rotated in the ingression direction, as shown in FIG. 3a.

Therefore, the pusher 204 of the pusher arm 200 pushes the selective arm 500 rightward. By the rightward movement of the selective arm 500, the locker 406 of the locker arm 400 is disengaged from the locker cut 504a of the selective arm 500, thereby allowing the locker arm 400 to be freely rotated.

In this condition, the disk “D” is caught by the protrusions 310 of the guide arm 300 and then rearwardly moved into the player body 1. At this time, the locker arm 400, which is connected to the guide arm 300, is rotated about the locker pin 108 so that the central point of the disk “D” is rearwardly moved to the center of the turntable 3.

During the rearward movement of the disk “D” to the center of the turntable 3, the selector lever 10, which is positioned in a condition of pushing the pusher arm 200, is restored to its normal position by resilience of the spring 12, and the pusher arm 200 is also restored to the normal position by the spring 208, so that the pusher 204, which is positioned in a condition of pushing the selective arm 500, is disengaged from the selector arm 500. Accordingly, the selective arm 500 is intended to be moved leftward, i.e., to be restored to its normal position by restoring force of the spring 516.

Subsequently, when the central point of the disk “D” arrives at the center of the turntable 3, the selective arm 500 is moved leftward so that the locker 406 of the locker arm 400 is engaged to the rear locker cut 504b of the selective arm 500, as shown in FIG. 3b. At the same time, the selective arm 500 is engaged to the pin 604 of the stopper 600 and locker arm 400 is caught to stop its rotation. Accordingly, the guide arm 300 is stopped from moving rearward, and thus the disk “D” is seated on the turntable 3 with the central point of the disk “D” being positioned at the center of the turntable 3.

In this case, since the disk “D” is moved rearward while being guided by the protrusions 310 of the guide arm 300, the disk “D” can be centrally positioned at the turntable 3.

When the disk “D” is centrally positioned at the turntable 3, the clamp arm 100 is downwardly rotated about the hinge axis such that the clamp 102 of the clamp arm 100 can clamp the disk “D”.

At this point, the push plate 606 of the stopper 600 is upwardly pushed, and thus the pin 604, which is in engagement with the selective arm 500, is lowered, so that the selective arm 500 is rotated clockwise by restoring force of the spring 516 to rotate the locker arm 400 to the same direction, thereby allowing the guide arm 300 connected to the locker arm 400 to be some more moved rearwardly, as shown in FIG. 3c.

Thereafter, the protrusions 310 of the guide arm 300 are separated from the disk “D”, thereby allowing the disk “D” to be freely rotated.

Secondly, an operation of the disk guide device according to the present invention is described when an 80 mm disk is loaded into the player body.

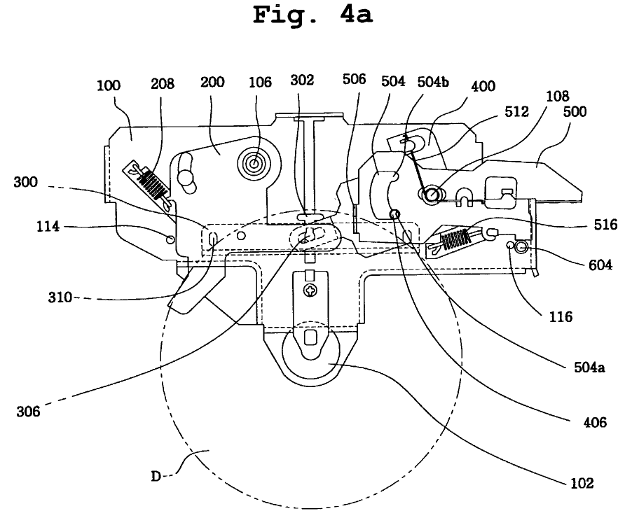

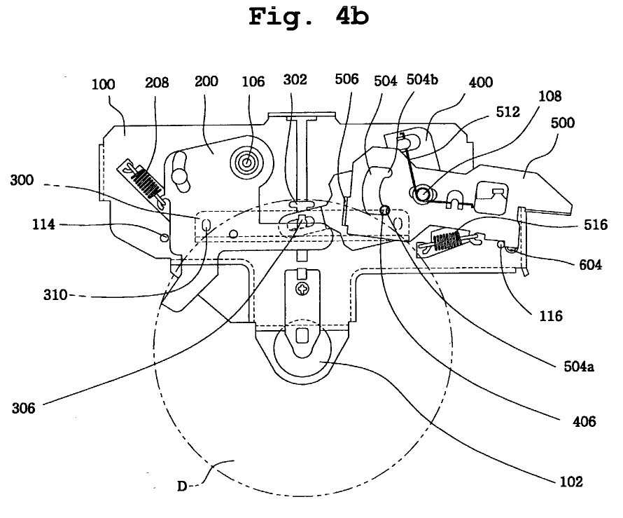

In this case, since the disk “D” is reduced in its diameter, the disk “D” does not come into contact with the selector lever 10, so that the disk “D” is moved rearwardly without causing motion of the pusher arm 200, the locker arm 400 and the selector arm 500 until the disk “D” comes into contact with its circumference to protrusions 310 of the guide arm 300, as shown in FIG. 4a.

In this case, even though the disk “D” is unevenly inserted into the player body, the disk “D” collides with either of both the pair of protrusions 310 and then comes into contact with the both protrusions 310, so that the disk “D” is precisely positioned on the center of the turntable 3.

As the disk “D” is moved rearward while being engaged to the both protrusions 310 of the guide arm 300, the locker arm 400 is rotated about the locker pin 108 and thus the selective arm 500 is also rotated.

When the selective arm 500 is caught by the pin 604 of the stopper 600, the disk “D” is precisely positioned at the center of the turntable 3 and then seated on the turntable 3.

After the disk “D” is seated on the turntable 3, the clamp arm 100 is downwardly rotated about the hinge axis such that the clamp 102 can clamp the disk “D”.

At this point, the push plate 606 of the stopper 600 is pushed by the player body 1 and thus the stopper 600 is rotated about its hinge axis, thereby causing the pin 604 in engagement to the selective arm 500 to be lowered. By the lowering of the pin 604, the selective arm 500 is further rotated clockwise by restoring force of the spring 516, thereby causing to locker arm 40 to be rotated, as shown in FIG. 4b. Therefore, the guide arm 300 connected to the locker arm 400 is further moved rearwardly.

At this point, the protrusions 310 of the guide arm 300 are separated from the disk “D”, so that the disk “D” is freely rotated.

As such, the disk guide device according to the present invention enables only one compact disk player to drive any of disks different from each other in diameter, i.e., any of an 80 mm disk and a 120 mm disk, to play back data recorded on the disk.

Since the disk guide device according to the present invention is reduced in the number of components as compared with a conventional disk guide device, it is possible to achieve improved assembly efficiency, and, since the disk guide device guides a disk while moving linearly, a failure rate is decreased.

As described above, the present invention provides a disk guide device of a compact disk player for an automobile which is adapted to be conveniently used regardless of type of a disk by enabling only one mechanism to drive an 80 mm disk as well as a 120 mm disk. Accordingly, the disk guide device according to the present invention is economical and practical since there is no necessity to provide of separate compact disk players to drive two types of disks. Furthermore, since the guide arm is adapted to guide a disk while moving linearly, it is possible to achieve favorable operational smoothness and decrease of failure rate.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A disk guide device of a compact disk player for an automobile comprising:
a clamp arm mounted on a main body, which is hingedly connected at its rear part to the main body and is provided at its front part with a clamp to selectively press a central portion of a disk;
a guide arm disposed under the clamp arm to be moved back and forth, which is provided at both ends of a lower surface of the clamp arm with a pair of protrusions to precisely guide the disk to the center of a turntable; and
a selective disk reception mechanism disposed on the clamp arm, which is adapted to move the guide arm rearwardly to receive a larger disk thereinto.

2. The disk guide device as set forth in claim 1, in which the selective disk reception mechanism comprises:
a pusher arm coupled to an upper surface of the clamp arm to be rotated to a certain angle with respect to the clamp arm, which is provided with a pusher, the pusher being extended outwardly and being biased to be rotated in the opposite direction of the ingression direction of a disk by spring;
a locker arm rotatably coupled to an upper surface of the clamp arm, which is connected at one end to the guide arm to bias the guide arm forwardly by a torsion spring and is provided at its upper surface with a protruded locker for selectively interrupting turning force of the locker arm;
a selective arm coupled to an upper surface of the locker arm to be rotated together with the locker arm to a certain angle and to be moved laterally, which is provided at one end with a protrusion piece to be selectively put into contact with the pusher and is provided at a portion with a locker guide hole for guiding the locker during rotation of the locker arm, the locker guide hole being formed at its front and rear sides with a pair of locker cuts into which the locker is engaged, and being biased to be rotated in the opposite direction of the ingression direction of a disk by spring; and
a stopper hingedly coupled at its middle portion to a lower surface of the clamp arm to be rotated up and down, which is provided at its front end with a pin by which the selective arm is caught during its rotation, the pin passing through the clamp arm and being upwardly protruded, and is integrally provided at its rear end with a push plate, a compression spring being disposed between the push plate and the clamp arm to elastically press the push plate upwardly.

3. The disk guide device as set forth in claim 1 or 2, in which the clamp arm is formed at its center line with slot opening rearward, and the guide arm is provided at the center point of its upper surface with a slider which is inserted into the slot of the clamp arm and slid along the slot, the slider being provided at its both sides with lateral extensions.

4. The disk guide device as set forth in claim 2, in which the clamp arm is provided at its upper surface with a pusher pin protruded upwardly, and the pusher arm is rotatably fitted to the pusher pin.

5. The disk guide device as set forth in claim 2, in which the clamp arm is provided at its upper surface with a locker pin protruded upwardly, and the locker arm is rotatably coupled to the locker pin, the selective arm being formed with a locker guide hole to be moved laterally.

6. The disk guide device as set forth in claim 2, in which, when the selective arm is caught by the pin of the stopper, the guide arm is rearwardly moved by a distance required to position the center of a disk at the center of the turntable, and, after the selective arm is rotated to the limit point by lowering of the pin of the stopper, the guide arm is further moved rearwardly to be separated from the disk.

7. The disk guide device as set forth in claim 2, in which the clamp arm is provided at both side of its upper surface with a pair of checking protrusions to limit rotating ranges of the pusher arm and the selective arm.

8. The disk guide device as set forth in claim 2, further comprising a selector lever disposed under an upper frame of the player body, which is rotated to push the pusher arm to cause the pusher of the pusher arm to be rotated in the ingression direction of a disk, and a spring for causing the selector lever to be restored to its normal position when the central point of a disk is located at the center of the turntable.

9. The disk guide device as set forth in claim 3, in which the slider of the guide arm is provided at its upper surface with a protruded pin, which is inserted into an elongated hole formed at one end of the locker arm, and the protruded pin of the slider is provided with a retaining piece to prevent the locker arm from being separated from the protruded pin during an operation of the locker arm.
